(19) United States
(12) Patent Application Publication
(10) Pub. No.: US 2007/0285604 A1
(43) Pub. Date: Dec. 13, 2007

(54) PROTECTION SHEET AND LIQUID CRYSTAL DISPLAY INCLUDING THE SAME

(76) Inventors: Tae-hyung Kim, Suwon-si (KR); Jun-hee Son, Suwon-si (KR); Jeoung-gwen Lee, Suwon-si (KR)

Correspondence Address: Frank Chau, Esq.;F. CHAU & ASSOCIATES, LLC, 1900 Hempstead Turnpike, Suite 501, East Meadow, NY, 11554, US

(21) Appl. No.: 11/611,556

(22) Filed: Dec. 15, 2006

(30) Foreign Application Priority Data
Jun. 12, 2006 (KR) 10-2006-0052468

(51) Int. Cl. G02F 1/1333

(52) U.S. Cl. 349/122

(57) ABSTRACT

A protection sheet comprises a base layer comprising an optically transparent resin, a coating layer formed on at least one surface of the base layer, and beads dispersed in the coating layer, the beads comprising a resin having a Rockwell hardness of less than M90. The coating layer comprises a lubricant. The lubricant comprises a polysiloxane copolymer.

### CROSS-REFERENCE TO RELATED APPLICATION

This application claims priority from Korean Patent Application No. 10-2006-0052468 filed on Jun. 12, 2006, the disclosure of which is incorporated herein by reference in its entirety.

### BACKGROUND OF THE INVENTION

1. Technical Field

The present disclosure relates to a protection sheet and a liquid crystal display comprising the same, and more particularly to a protection sheet capable of enhancing display quality, and a liquid crystal display comprising the same.

2. Discussion of the Related Art

Liquid crystal displays (LCDs) typically include a liquid crystal panel assembly and may include a backlight assembly. The liquid crystal panel receives light from an external and/or internal light source and displays images. The backlight assembly, which is an example of an internal light source, emits light using a light source such as, for example, a lamp. The liquid crystal panel assembly includes a liquid crystal panel and a pair of polarizing plates. The liquid crystal panel includes a first substrate on which color filters and a common electrode are formed, a second substrate on which thin film transistors (TFTs) and a pixel electrode are formed, and a liquid crystal layer disposed between the first substrate and the second substrate. The pair of polarizing plates is positioned on upper and lower surfaces of the liquid crystal panel.

The backlight assembly is disposed under the liquid crystal panel assembly and supplies the liquid crystal panel assembly with light. The backlight assembly includes a lamp unit as a light source and optical sheets for diffusing light and enhancing brightness.

In conventional LCDs, since the optical sheets contact the polarizing plates, the polarizing plates or the optical sheets may be damaged due to the friction therebetween, resulting in deterioration of the display quality. Accordingly, there is a need to provide a protection sheet preventing damage such as scratches on the polarizing plates or the optical sheets.

### SUMMARY OF THE INVENTION

According to an embodiment of the present invention, a protection sheet includes a base layer comprising an optically transparent resin, a coating layer formed on at least one surface of the base layer, and beads dispersed in the coating layer, the beads comprising a resin having a Rockwell hardness of less than M90.

According to an embodiment of the present invention, a protection sheet includes a base layer comprising an optically transparent resin, and a coating layer comprising a resin having a Rockwell hardness of less than M90, wherein the coating layer is formed on at least one surface of the base layer and has an irregular surface.

According to an embodiment of the present invention, a liquid crystal display (LCD) includes a liquid crystal panel assembly including a liquid crystal panel having polarizing plates on its bottom and upper surfaces, and a backlight assembly including a lamp unit providing the liquid crystal panel with light, an optical sheet diffusing the light provided from the light unit, and a protection sheet disposed between the optical sheet and each of the polarizing plates, wherein the protection sheet includes a base layer comprising an optically transparent resin, and a first coating layer formed on one surface of the base layer facing the polarizing plates, wherein beads are dispersed in the first coating layer, the beads comprise a resin having a Rockwell hardness of less than M90.

According to an embodiment of the present invention, there is provided a liquid crystal display (LCD) including a liquid crystal panel assembly including a liquid crystal panel having polarizing plates on its bottom and upper surfaces, and a backlight assembly including a lamp unit providing the liquid crystal panel with light, an optical sheet diffusing the light provided from the light unit and enhancing brightness, and a protection sheet disposed between the optical sheet and each of the polarizing plates, wherein the protection sheet includes a base layer made of an optically transparent resin, and a first coating layer formed on one surface of the base layer facing the polarizing plates, wherein the first coating layer comprises a resin having a Rockwell hardness of less than M90 and has an irregular surface.

### BRIEF DESCRIPTION OF THE DRAWINGS

Exemplary embodiments of the present invention can be understood in more detail from the following description taken in conjunction with the accompanying drawings in which:

FIG. 1 is an exploded perspective view illustrating a liquid crystal display device in accordance with an embodiment of the present invention;

FIG. 2 is a cross-sectional view taken along the line II-II′ in FIG. 1 according to an embodiment of the present invention;

FIG. 3 is an enlarged view illustrating a portion “A” shown in FIG. 2 according to an embodiment of the present invention;

FIG. 4 is a cross-sectional view illustrating a protection sheet according to an embodiment of the present invention; and

FIG. 5 is a cross-sectional view illustrating a protection sheet according to an embodiment of the present invention.

### DETAILED DESCRIPTION OF EXEMPLARY EMBODIMENTS

Exemplary embodiments of the present invention will be described below in more detail with reference to the accompanying drawings. The present invention may be embodied in many different forms and should not be construed as limited to the embodiments set forth herein.

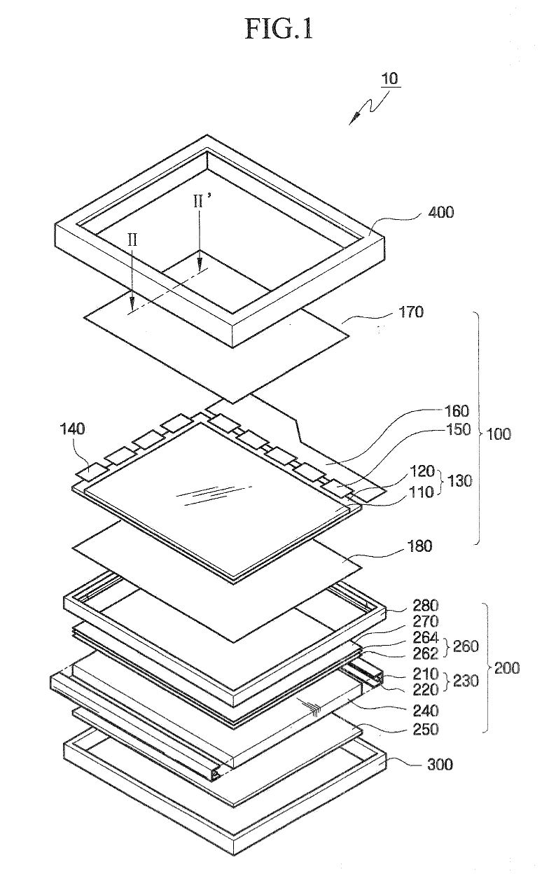

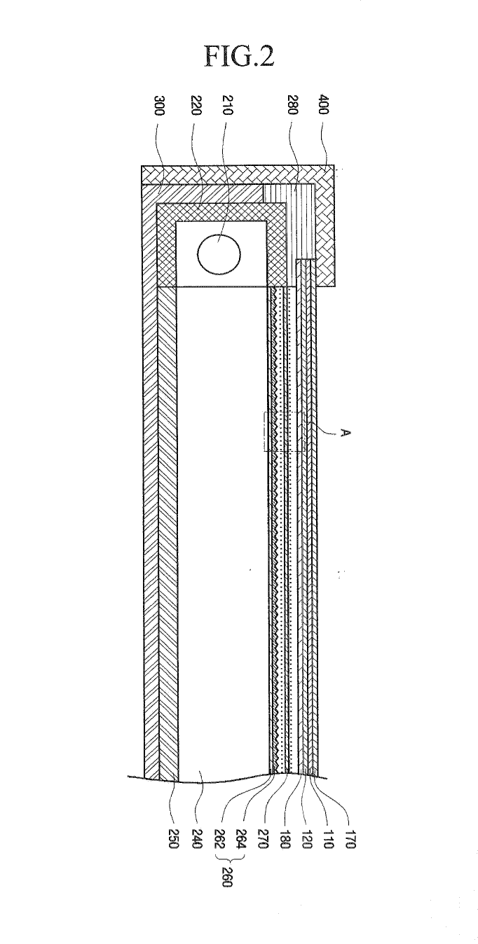

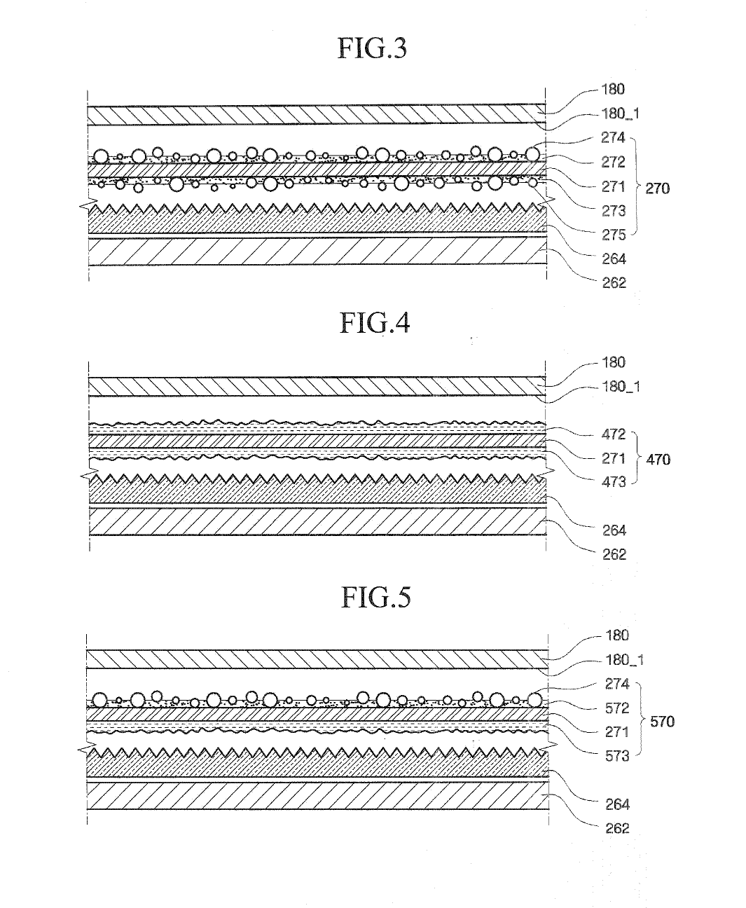

A liquid crystal display according to an embodiment of the present invention is described with reference to FIGS. 1 through 3. FIG. 1 is an exploded perspective view illustrating a liquid crystal display 10 in accordance with an embodiment of the present invention. FIG. 2 is a cross-sectional view taken along the line II-II′ in FIG. 1 according to an embodiment of the present invention. FIG. 3 is an enlarged view illustrating a portion “A” shown in FIG. 2.

Referring to FIG. 1, the liquid crystal display 10 includes a liquid crystal panel assembly 100, a backlight assembly 200, a bottom receiving container 300 and a top receiving container 400.

In an embodiment, the liquid crystal panel assembly 100 includes a liquid crystal panel 130, a gate driving chip package 140, a data driving chip package 150, a printed circuit board (PCB) 160, and first and second polarizing plates 170 and 180.

The liquid crystal panel 130 is positioned between the first and second polarizing plates 170 and 180, and includes a first substrate 110 on which color filters and a common electrode are formed, a second substrate 120 on which thin film transistors (TFTs) and a pixel electrode are formed, and a liquid crystal layer (not shown) disposed between the first substrate 110 and the second substrate 120.

Gate driving signals are supplied to the gate driving chip package 140 and data driving signals are supplied to the data driving chip package 150. A timing controller (not shown), a memory (not shown) and other circuit device (not shown) are integrated on the PCB 160.

The first and second polarizing plates 170 and 180 are attached to the upper and lower surfaces of the liquid crystal panel assembly 100 with their polarizing axes disposed perpendicular to, parallel to or at a predetermined angle with respect to each other. The first and second polarizing plates 170 and 180 may have a plurality of layers comprising, for example, an optically transparent resin.

The backlight assembly 200 includes a lamp unit 230, a light guide plate 240, a reflection plate 250, an optical sheet 260, a protection sheet 270, and a mold frame 280.

The lamp unit 230 includes a lamp 210 and a lamp cover 220 for supporting and protecting the lamp 210. The lamp 210 may employ, for example, a linear light source such as a Cold Cathode Fluorescent Lamp (CCFL), or a Hot Cathode Fluorescent Lamp (HCFL), or a point light source such as a Light Emitting Diode (LED). Although an edge-type backlight is illustrated in FIG. 1, another type of backlight such as, for example, a direct-type backlight, in which a plurality of lamps are arranged in parallel, may be used according to an embodiment of the present invention.

The light guide plate 240 comprises a plastic-based, transparent material, such as, for example, acrylate, so that the light generated by the lamp 210 can travel toward the liquid crystal panel assembly 100. Thus, a variety of patterns for shifting the traveling direction of the light incident onto the light guide plate 240 toward the liquid crystal panel assembly 100 may be formed on the rear surface of the light guide plate 240.

The reflection plate 250 is disposed below the bottom surface of the light guide plate 240, and thus reflects the portion of the light that is not reflected by fine dot patterns formed on the rear surface of the light guide plate 240 back toward the emission surface of the light guide plate 240. The reflection plate 250 may be integrally formed on the bottom surface of the bottom receiving container 300.

The optical sheet 260 is disposed on the top surface of the light guide plate 240, diffuses the light emitted from the light guide plate 240 and enhances brightness. The optical sheet 260 includes a diffusion sheet 262 and a prism sheet 264.

Referring to FIG. 2, the diffusion sheet 262, which is disposed on the top surface of the light guide plate 240, diffuses the light emitted from the light guide plate 240. The prism sheet 264 is disposed on the top surface of the light guide plate 240, and collects the light that diffuses from the diffusion sheet 262 in a direction perpendicular to the liquid crystal panel assembly 100, thereby increasing the brightness.

Referring to FIG. 3, the prism sheet 264 may have a predetermined arrangement of triangular prism patterns on a surface of the prism sheet 264. The prism sheet 264 may comprise a single sheet as illustrated in FIG. 3. In an embodiment, the prism sheet 264 may have two sheets of prism patterns each having surface patterns arranged alternately at a predetermined angle.

The protection sheet 270 is positioned between the optical sheet 260 and the second polarizing plate 180. The protection sheet 270 can prevent damages such as scratches on the optical sheet 260 or the second polarizing plate 180. Referring to FIG. 3, the protection sheet 270 includes a base layer 271, first and second coating layers 272 and 273, and beads 274 and 275 dispersed in the first and second coating layers 272 and 273.

The base layer 271 comprises, for example, an optically transparent resin. Examples of the base layer 271 include polyethylene terephthalate (PET), polyethylene naphthalate (PEN), an acryl resin, polycarbonate (PC), polystyrene (PS), polyamide (PA), polyolefin, cellulose acetate, polyimide, and weatherable vinyl chloride.

The first and second coating layers 272 and 273 can be binders for fixing the beads 274 and 275. In an embodiment, the first and second coating layers 272 and 273 comprise optically transparent resins, for example, an acryl resin, a polyurethane (PU) resin, a urea resin, a melamin resin, a phenol resin, an epoxy resin, an unsaturated polyester resin, a urethane resin, a silicon resin, or polyamide imide.

As shown in FIG. 3, the beads 274 and 275 are dispersed in the first and second coating layers 272 and 273. Contact stress applied to the second polarizing plate 180 and the prism sheet 264 can be minimized through formation of the beads 274 and 275.

A contact type can be a surface-surface contact, a surface-spot contact, and a spot-spot contact. Contact stress due to the surface-surface contact causes the most severe damage. The beads 274 and the second polarizing plate 180, or the beads 275 and the prism sheet 264 have a spot-surface or spot-spot contact with each other, so that a contact stress due to a contact therebetween can be minimized. A contact stress applied to the second polarizing plate 180 or the prism sheet 264 can be minimized, thereby suppressing scratches from being generated on the second polarizing plate 180 or the prism sheet 264.

The beads 274 and 275 may comprise a resin having a hardness smaller than that of a surface 180_1 of the second polarizing plate 180 being in contact therewith. When the beads 274 and 275 comprise a resin having a hardness smaller than that of a surface 180_1 of the second polarizing plate 180, even if the second polarizing plate 180 contacts the beads 274 and 275, no scratches are created on the second polarizing plate 180. In an embodiment, the beads 274 and 275 may comprise a resin having a hardness smaller than that of prism patterns on the surface of the prism sheet 264. In an embodiment, the beads 274 and 275 may comprise a resin having a Rockwell hardness of less than M90, for example, a polyurethane (PU) resin.

The Rockwell hardness can be measured in two steps. In the first step, the primary load of 10 kgf is applied to indented particles and the indented particles are contacted with a test specimen to be measured.

In the second step, while the primary load is still being applied, the major load is additionally applied to the compressed particles to shape deeper indentation. Thereafter, the major load is removed and the hardness evaluation is done by measuring a difference between indentation lengths resulting from the application of the primary load and the major load.

In an embodiment, the M scale is measured under conditions of indented particles having a diameter of 6.35 mm and the primary load of 100 kgf, and the R scale is measured under conditions of indented particles having a diameter of 12.7 mm and the primary load of 60 kgf. Polyurethane (PU) is a resin having the Rockwell hardness (R scale) of approximately 60 and the Rockwell hardness (M scale) of not greater than 90.

The first and second coating layers 272 and 273 may further comprise a lubricant. The lubricant softens surfaces of the first and second coating layers 272 and 273 and surfaces of the beads 274 and 275. The lubricant reduces the occurrence of damage such as scratches due to contact stress when the second polarizing plate 180 contacts the first coating layer 272 or the beads 274 or when the prism sheet 264 contacts the second coating layer 273 or the beads 275. Accordingly, damage such as scratches on the second coating layer 273 and the prism sheet 264 can be suppressed.

In an embodiment of the present invention, the lubricant may comprise, for example, a polysiloxane copolymer, polytetrafluoroethylene (PTFE), or polyethylene (PE).

In an embodiment, the protection sheet 270 comprises both the first and the second coating layers 272 and 273, and the beads 274 and 275 comprising the same resin are dispersed in the first and second coating layers 272 and 273, respectively. In an embodiment, the protection sheet 270 may comprise only the first coating layer 272. In an embodiment, the beads 274 and 275 dispersed in the first coating layer 272 or in both the first and second coating layers 272 and 273 may comprise different kinds of resin materials. The sizes, types and shapes of the beads 274 and 275 can vary.

The beads 274 and 275 may be dispersed in the first and the second coating layers 272 and 273 in different amounts. In an embodiment, the amount of the beads 274 dispersed in the first coating layer 272 is greater than the amount of the beads 275 dispersed in the second coating layer 273.

The reflection plate 250 is disposed below the light guide plate 240 and reflects the light supplied from the lamp 210 back toward the liquid crystal panel assembly 100. The reflection plate 250 may be integrally formed on the bottom surface of the bottom receiving container 300.

The mold frame 280 supports and fixes the optical sheet 260, the lamp unit 230, and the liquid crystal panel assembly 100.

FIG. 4 is a cross-sectional view illustrating a protection sheet 470 according to an embodiment of the present invention.

Referring to FIG. 4, the protection sheet 470 includes a base layer 271, and first and second coating layers 472 and 473.

The first and second coating layers 472 and 473 comprise a resin having a Rockwell hardness of less than M90 and have irregular surfaces. The irregular surfaces perform similar functions as the beads 274, 275 provided in the protection sheet 270 of the embodiment described in connection with FIG. 3.

The irregular surfaces of the first and second coating layer 472 and 473 cause a spot-surface or a spot-spot contact between the second polarizing plate 180 and the protection sheet 470 and the prism sheet 264 and the protection sheet 470, so that the contact stress due to a contact therebetween can be minimized. The irregular surfaces, comprising a flexible resin having a Rockwell hardness of less than M90, suppress scratches from being generated on the second polarizing plate 180. Similarly, the irregular surface of the second coating layer 473 suppress scratches from being generated on the prism sheet 264.

In addition, the first and second coating layers 472 and 473 may further comprise a lubricant. The lubricant may comprise, for example, a polysiloxane copolymer, polytetrafluoroethylene (PTFE), or polyethylene (PE). The lubricant softens surfaces of the first and second coating layers 472 and 473 respectively contacting the second polarizing plate 180 and the prism sheet 264. The softened first and second coating layers 472 and 473 minimizes the contact stress, thereby minimizing scratches on the second polarizing plate 180 and the prism sheet 264.

The irregular surfaces of the first and second coating layers 472 and 473 may be formed by extrusion or other various forming methods. For example, the irregular surfaces may be formed by extruding a PU resin using a sand-blasted polishing roll.

In an embodiment, the protection sheet 470 comprises both the first and the second coating layers 472 and 473, wherein each layer may comprise a different resin material. In an embodiment, the protection sheet 470 may comprise only the first coating layer 472.

Patterns of the irregular surfaces of the first and second coating layers 472 and 473 may vary. For example, the roughness of the irregular surface formed on the first coating layer 472 may be greater than that of the irregular surface formed on the second coating layer 473. There is no particular limitation placed on the type of the irregular surfaces formed on the first and the second coating layers 472 and 473. For example, the irregular surfaces may have a random pattern formed on the first and the second coating layers 472 and 473.

FIG. 5 is a cross-sectional view illustrating a protection sheet 570 according to an embodiment of the present invention.

Referring to FIG. 5, the protection sheet 570 includes the base layer 271, a first coating layer 572, the beads 274, and a second coating layer 573. The beads 274 are dispersed in the first coating layer 572 and an irregular surface is formed on the second coating layer 573. In an embodiment, the beads 274 may comprise a resin having a Rockwell hardness of less than M90, or example, a PU resin. The second coating layer 573 may comprise a resin having a Rockwell hardness of less than M90, for example, a PU resin.

The first and second coating layers 572 and 573 may further comprise a lubricant. The lubricant may comprise, for example, a polysiloxane copolymer, polytetrafluoroethylene (PTFE), or polyethylene (PE).

The protection sheet 570 according to an embodiment of the present invention can minimize the contact stress, so that scratches can be suppressed from being generated on the second polarizing plate 180 and the prism sheet 264.

In an embodiment, the protection sheet 570 may be arranged in an LCD such that the second coating layer 573 faces the second polarizing plate 180 and the first coating layer 572 and the beads 274 face the prism sheet 264.

According to embodiments of the present invention, a protection sheet and a liquid crystal display comprising the same can reduce scratches on the polarizing plates, thereby achieving an improved display quality.

Although exemplary embodiments have been described with reference to the accompanying drawings, it is to be understood that the present invention is not limited to these precise embodiments but various changes and modifications can be made by one skilled in the art without departing from the spirit and scope of the present invention. All such changes and modifications are intended to be included within the scope of the invention as defined by the appended claims.

What is claimed is:

1. A protection sheet comprising:
a base layer comprising an optically transparent resin;
a coating layer formed on at least one surface of the base layer; and
beads dispersed in the coating layer, the beads comprising a resin having a Rockwell hardness of less than M90.

2. The protection sheet of claim 1, wherein the coating layer comprises a lubricant.

3. The protection sheet of claim 2, wherein the lubricant comprises a polysiloxane copolymer.

4. The protection sheet of claim 2, further comprising a second coating layer comprising the resin having the Rockwell hardness of less than M90, wherein the second coating layer is formed on a surface of the base layer other than the at least one surface on which the coating layer is formed, wherein the second coating layer has an irregular surface.

5. A protection sheet comprising:
a base layer comprising an optically transparent resin; and
a coating layer comprising a resin having a Rockwell hardness of less than M90, wherein the coating layer is formed on at least one surface of the base layer and has an irregular surface.

6. The protection sheet of claim 5, wherein the coating layer comprises a lubricant.

7. The protection sheet of claim 6, wherein the lubricant comprises a polysiloxane copolymer.

8. A liquid crystal display (LCD) comprising:
a liquid crystal panel assembly including a liquid crystal panel having polarizing plates on bottom and upper surfaces of the liquid crystal panel; and
a backlight assembly including a lamp unit providing the liquid crystal panel with light, an optical sheet diffusing the light provided from the lamp unit, and a protection sheet disposed between the optical sheet and each of the polarizing plates,
wherein the protection sheet comprises a base layer comprising an optically transparent resin, and a first coating layer formed on a first surface of the base layer facing the polarizing plates, wherein beads are dispersed in the first coating layer and the beads comprise a resin having a Rockwell hardness of less than M90.

9. The liquid crystal display of claim 8, wherein the first coating layer comprises a lubricant.

10. The liquid crystal display of claim 9, wherein the lubricant comprises a polysiloxane copolymer.

11. The liquid crystal display of claim 8, further comprising:
a second coating layer formed on a second surface of the base layer; and
beads dispersed in the second coating layer and comprising a resin having the Rockwell hardness of less than M90.

12. The liquid crystal display of claim 11, wherein the second coating layer comprises a lubricant.

13. The liquid crystal display of claim 12, wherein the lubricant comprises a polysiloxane copolymer.

14. The liquid crystal display of claim 8, wherein the protection sheet further comprises a second coating layer comprising a resin having the Rockwell hardness of less than M90, wherein the second coating layer is formed on a second surface of the base layer and has an irregular surface.

15. A liquid crystal display (LCD) comprising:
a liquid crystal panel assembly including a liquid crystal panel having polarizing plates on bottom and upper surfaces of the liquid crystal panel; and
a backlight assembly including a lamp unit providing the liquid crystal panel with light, an optical sheet diffusing the light provided from the lamp unit and enhancing brightness, and a protection sheet disposed between the optical sheet and each of the polarizing plates,
wherein the protection sheet comprises a base layer comprising an optically transparent resin, and a first coating layer formed on a first surface of the base layer facing the polarizing plates, wherein the first coating layer comprises a resin having a Rockwell hardness of less than M90 and has an irregular surface.

16. The liquid crystal display of claim 15, wherein the first coating layer comprises a lubricant.

17. The liquid crystal display of claim 16, wherein the lubricant comprises a polysiloxane copolymer.

18. The liquid crystal display of claim 15, wherein the protection sheet further comprises a second coating layer comprising a resin having the Rockwell hardness of less than M90, wherein the second coating layer is formed on a second surface of the base layer and has an irregular surface.

19. The liquid crystal display of claim 18, wherein the second coating layer comprises a lubricant.

20. The liquid crystal display of claim 19, wherein the lubricant comprises a polysiloxane copolymer.
